(19) United States
(12) Patent Application Publication
(10) Pub. No.: US 2007/0000894 A1
(43) Pub. Date: Jan. 4, 2007

(54) Welding torch device for connection to a welding robot

(76) Inventor: Thomas Klein, Otterbach (DE)

Correspondence Address: MCGLEW & TUTTLE, PC, P.O. BOX 9227, SCARBOROUGH STATION, SCARBOROUGH, NY, 10510-9227, US

(21) Appl. No.: 10/595,896

(22) PCT Filed: Nov. 19, 2004
(86) PCT No.: PCT/EP04/13172

§ 371 Date: May 18, 2006

(30) Foreign Application Priority Data
Nov. 21, 2003 (DE) 10354880.7

(51) Int. Cl. B23K 9/32

(52) U.S. Cl. 219/137.9

(57) ABSTRACT

The invention relates to a welding torch device (7) of a welding robot (1), which is provided for electric arc welding, in particular MIG welding or MAG welding. The aim of the invention is to relieve the supply lines during rotational movement and to advantageously adapt them to the welding robot. Said type of welding robot, generally comprises a robot arm (3) whereon a connection flange (6) is fixed thereto and can rotate in relation to the robot arm. The welding torch device comprises a fixing device and a receiving device. A connection for a welding power cable (18) can be electrically connected to a welding power source on the robot side of the welding torch device. The welding torch device also comprises a current transfer device via which the welding power cable can be electrically connected to a welding torch side of the welding torch device. The current transfer device comprises a stator which is rotationally fixed to the arrangement in relation to the robot arm, however, it can rotate in relation to the connection flange (6) of the welding robot. The stator comprises a leadthrough, through which at least one welding medium required for the welding process, can be guided in the direction of the receiving device. According to the invention, the securing device (9) of the rotor, which is embodied for attaching the connection device of the robot, is configured and mounted on the connection device of the robot such that a rotational axis of the rotor is at least essentially aligned in relation to the rotational axis (8) of the connection device of the robot and can be rotated about said rotational axis.

### CROSS REFERENCE TO RELATED APPLICATIONS

This application is a United States National Phase application of International Application PCT/EP2004/013172 and claims the benefit of priority under 35 U.S.C. § 119 of German Patent Application DE 103 54 880.7 filed Nov. 21, 2003, the entire contents of which are incorporated herein by reference.

### FIELD OF THE INVENTION

The present invention pertains to a welding torch device of a welding robot, which is provided for electric arc welding, and in particular MIG [metal inert gas—Tr.] or MAG [metal active gas—Tr.] welding. Such a welding robot usually has a robot arm, on which is provided a connection flange that can be rotated in relation to the robot. The welding torch device comprises a fixing device for attaching the welding torch device to the welding robot as well as a receiving device for receiving a welding torch and transferring a preferably motor-driven rotatory motion to the welding torch. By means of a connection for a welding power cable, a robot side of the welding torch device can be electrically connected to a welding power source. The welding torch device also comprises a current transfer device, via which the welding power cable can be electrically connected to a welding torch side of the welding torch device, whereby the current transfer device has a stator that is provided for the rotationally fixed arrangement in relation to the robot arm, but can be rotated in relation to the connection flange of the welding robot. In this case, the stator shall be provided with a leadthrough, through which at least one of the welding media required for the welding process can be guided in the direction of the receiving device.

### BACKGROUND OF THE INVENTION

Automatic welding machines, and in particular folding arm robots, are almost exclusively used for performing arc welding in industrial mass production for automating such production processes. Such automatic welding machines are usually movable about a plurality of axes. By means of this mobility of the welding robot, it shall be achieved that the welding torch can also follow the whole length of welding paths of a complicated course. The actual welding torch, i.e., that component, by which the arc is guided to the respective workpiece, is usually arranged on a receiving device of a welding torch device. The welding torch device is in turn fixed at the free end of the robot arm via a flange, a locking ring or another fixing device.

However, the usually desired pivotability of the welding torch about an axis of a connection flange of the robot arm has been shown to be extremely problematic particularly in arc welding units. The welding torch is usually detachably fixed to this connection flange via components designated as a welding torch device. Previously, it was common to fix such welding torch devices to the robot via a bracket, whereby the pivot axis of the welding torch device is not identical to the rotational axis of the welding torch. In this case, the bracket accommodates the welding torch device usually at right angles to the rotational axis of the connection flange.

By means of the pivoting motion of the bracket resulting from this, the supply media required for MIG or MAG welding, such as the at least one power cable, an inert gas line, a welding wire and optionally also data lines, are heavily exposed to torsion. This frequently results in breaks in these supply media, which in turn results in unproductive downtimes of the respective welding unit. In addition, the supply media greatly restrict the mobility of the welding torch. Usually, the welding torch cannot be rotated more than ±180° in one direction of rotation because of the supply media. To avoid an excessively heavy load, the welding torch must subsequently be rotated back in the opposite direction of rotation. Consequently, apart from the restriction in possibilities of mobility already addressed, unproductive motions of the robot are also necessary, which increase the cycle times of production processes.

In order to achieve an improvement here, connecting the welding cable rigidly to a hollow-cylinder-shaped contact pin is suggested in DE 43 25 289 A, and in particular for manually guided welding torches. The contact pin shall in turn be inserted into a likewise hollow-cylinder-shaped, rotatable bushing, to which the welding torch is also connected. The device shown in DE 43 25 289 A1 shall then be clamped into the previously usual bracket for manual welding grips or automatic welding machines.

### SUMMARY OF THE INVENTION

Therefore, in welding torch devices of this class, which are provided for attaching to a folding arm robot, the basic object of the present invention is to create a technically advantageous connection possibility. Preferably, a possibility of endless rotation for welding torches shall also be able to be achieved.

This object is accomplished with a device of the type mentioned in the introduction according to the present invention by means of the fixing device of the rotor, which is designed for attaching to the connection device of the robot, wherein, by means of the attaching to the connection device of the robot, a rotational axis of the rotor is at least essentially coaxially aligned with the rotational axis of the connection device of the robot and the rotor can be rotated about the rotational axis of the connection device as well as about the stator.

On the one hand, the basic idea of the present invention is to provide the welding torch device with two components or sets of components, which are rotationally mobile in relation to each other. The fixing device to be attached to the welding robot shall be fixed in a rotationally fixed manner to the connection flange of the robot, while the connection flange on the robot side—and thus also the fixing device—can be rotated in relation to the stator carrying the current. The stator shall be statically, i.e., without possibility of rotation, detachably connected to a welding power cable coming from the welding power source. However, the receiving device carrying the actual welding torch can in turn be connected in a rotationally fixed manner—and thus also with the rotatingly driven connection device, such as, for example, a robot flange.

On the other hand, according to the present invention, the welding power cable shall not be guided to the welding torch past by the fixing device. In order to make possible an electric connection between the welding power cable on the robot side and the welding torch, a current transfer device, which can be guided through the fixing device, is provided on the welding torch device. To this end, the current transfer device has a connection for the power cable on the stator. The stator can, advantageously, be completely guided through the fixing device, preferably up to in the area of the welding torch. Compared to other conceivable embodiments, consequently at least sealants for the leadthrough carrying the inert gas can be largely avoided. Moreover, this solution makes it possible to transfer the current first in the area of the welding torch from the stator.

Via an electrically conductive contact means of the current transfer device, the current from the stator can preferably directly reach the receiving device and finally the welding torch. It may be particularly advantageous in this case if the stator and at least one part of the rotor, in particular the fixing device, are otherwise electrically insulated from one another. The current shall preferably be transferred exclusively through the contact means. Thus, no measures have to be made on the robot itself, so that this [robot] is not under current. Moreover, this quite considerably reduces the risk of electrical accidents, if operating personnel should manipulate the welding device, before the power is switched off. On the other hand, a mechanically especially stable and yet simple embodiment can be achieved in that the rotor is mounted on the current-carrying stator.

The expendable supplies necessary for the welding process used in each case, such as welding wire and/or insert gas, may, according to the present invention, reach the receiving device via the leadthrough of the stator on the robot side of the welding torch device. Preferably, the receiving device also has a leadthrough, by means of which the expendable supplies can be fed to the welding torch through the receiving device. Provisions may be made for a structurally particularly favorable embodiment by the axes of the two leadthroughs being aligned with one another, whereby the leadthrough of the receiving device surrounds the leadthrough of the stator.

The structural costs may be kept particularly low if inert gas and welding wire reach through the same recess of the leadthrough of the stator in the direction of the welding torch. However, it is also conceivable for a plurality of recesses to be provided for this. The structural cost can again be reduced if a wall defining the recess of the leadthrough of the stator is electrically conductive and is a component of the current transfer device of the welding current. Otherwise necessary, additional current-carrying medium can be omitted.

A data cable may likewise be inserted into the fixing device in the area of the stator and be guided out again at a suitable point. The data cable or even signal cable may detect or provide data or measured signals in the area of the welding torch device.

In another advantageous embodiment according to the present invention, provisions may be made for the welding current to be transferred to the receiving device by means of one or more sliding contacts. The at least one sliding contact may advantageously be provided in the area of an end of the welding torch device on the welding torch side, and in particular of the leadthrough.

A particularly favorable embodiment of the present invention may in this case provide a force load, and preferably a spring load, of the sliding contact, with which a constant contact of the sliding contact with a contact partner is guaranteed. It is particularly advantageous if the sliding contact is contacted by means of the force load both in the axial and radial directions of the rotational motion of the connection flange on the robot side. A reliable electrical contact can consequently be produced both with a rotationally fixed and with a rotating contact partner. Moreover, this solution has the advantage that production tolerances and a wearing of the sliding contact and of the contact partners can be compensated in broad ranges.

Furthermore, it may be expedient if—apart from the welding torch itself—the welding torch device, in particular the rotor and the stator, represent a structural unit. In order to arrange the welding torch device on a welding robot, it shall only be necessary to fix the welding torch device to the welding robot by means of its connection device of the rotor. For removal, only detaching the connection device, the welding power cable and optionally also detaching a data cable are then also necessary. Thus, in spite of the functionality of the welding device, a welding robot can be retrofitted in a particularly simple and quick manner.

Other preferred embodiments of the present invention appear from the claims, the specification and the drawings.

The present invention is explained in detail based on an exemplary embodiment shown purely schematically in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a highly schematic view of a folding arm robot provided as a welding robot;

FIG. 2 is a highly schematic, basic view of an embodiment of a welding torch device according to the present invention;

FIG. 3 is a detailed view of the welding torch device of FIG. 2;

FIG. 4 is a sectional view of a stator of the welding torch device from FIG. 3 together with a sliding contact means;

FIG. 5 is a lateral view of the set of components of FIG. 4;

FIG. 6 is a cross-sectional view of the sliding contact means;

FIG. 7 is an embodiment of a suitable folding arm robot; and

FIG. 8 is an enlarged detail view according to line A from FIG. 1.

### DESCRIPTION OF THE PREFERRED EMBODIMENTS

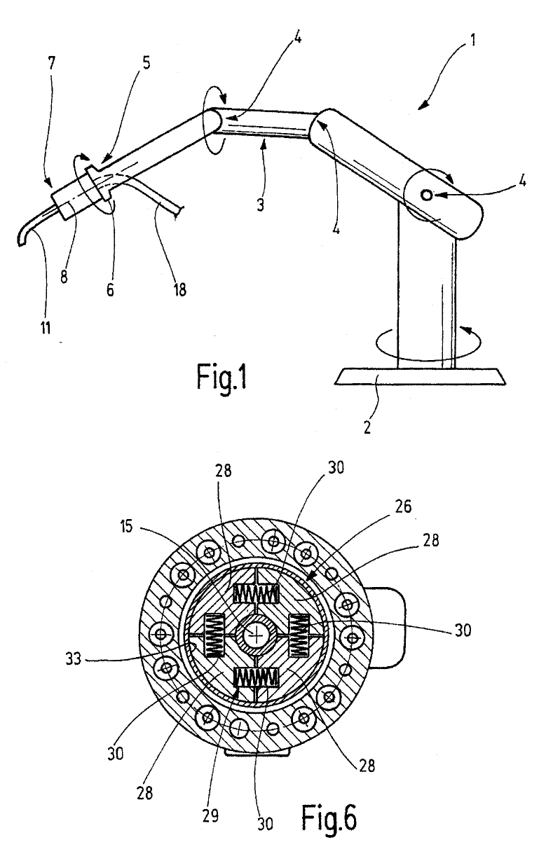

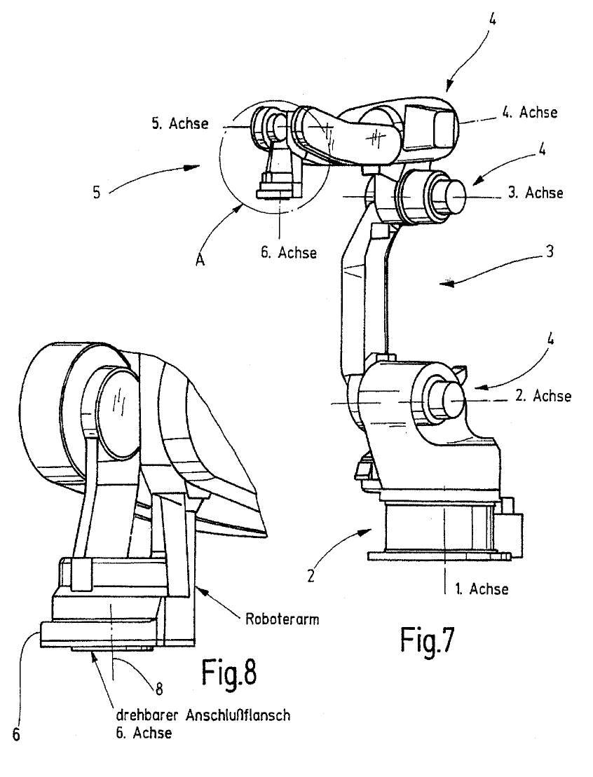

Referring to the drawings in particular, The folding arm robot 1 shown in FIGS. 1, 7 and 8 is a commercially available robot, as it is often used. For example, the robots of the EA series, which are offered by the company Motoman rototec GmbH, 85391 Allershausen, are suitable in conjunction with the present invention. The robot has a frame part 2 and an arm 3 arranged thereon, which is provided with a plurality of joints 4. The free end 5 of the arm of the folding arm robot is consequently capable of traveling the entire length of any three-dimensionally running paths of motion.

At the free end 5 of the arm 3, the robot is provided with a connection flange 6 of a connection device, which is provided for receiving a welding torch device 7 (FIG. 1). The connection flange 6 can perform a motor-driven rotational motion about a rotational axis 8 and in relation to the last member of the arm 3.

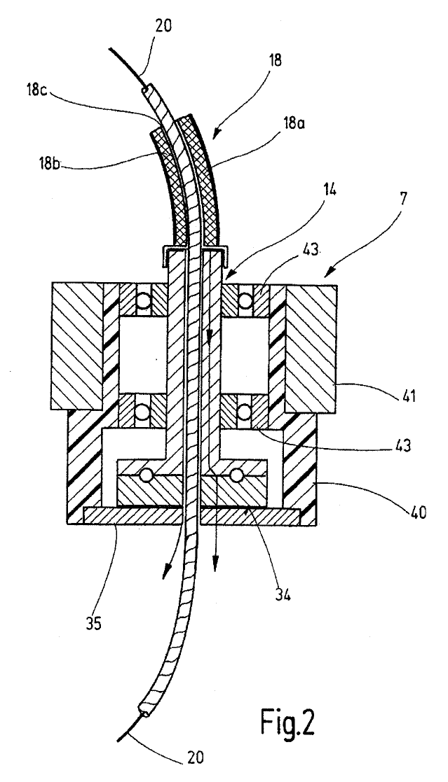

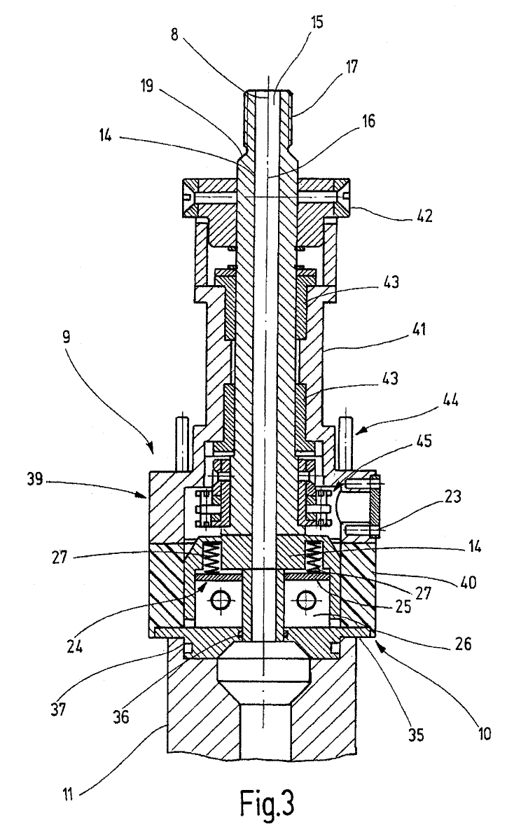

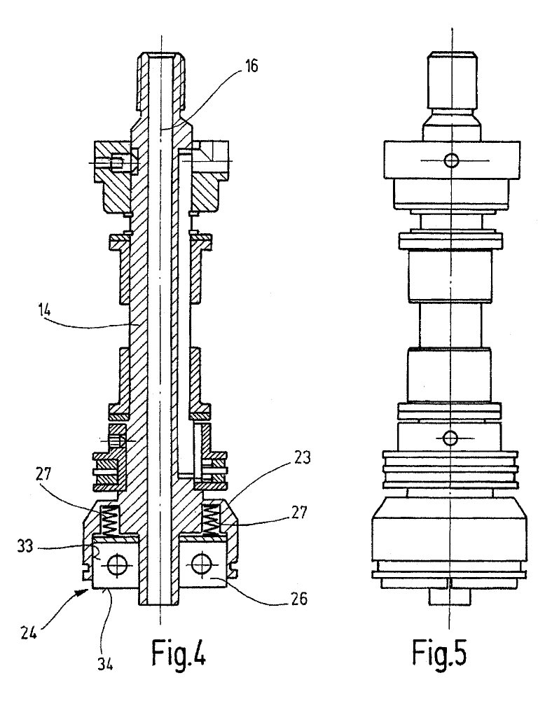

The welding torch device 7 shown in detail in FIGS. 2 through 6 has a fixing device 9 and a receiving device 10 (FIG. 3). The fixing device 9 is provided for connecting the welding torch device to the connection flange 6 of the robot arm 3 in a detachable, but rotationally fixed manner. On the other hand, the receiving device 10 is used for receiving a welding torch 11 and transferring welding current to the welding torch 11, which is explained in detail below. Since the receiving device 10 can be connected in a rotationally fixed manner to the connection flange 6 of the robot, performing rotational motions, via the fixing device 9 in a manner explained in detail below, the receiving device 10 and the fixing device 9 are also together designated as a rotor. The rotor can be rotated about the axis 8 in relation to the last member of the robot arm 3, to which the connection flange is attached.

A stator, which is rotationally fixed against the rotor and the last member of the robot arm 3, has a tubular leadthrough 14 arranged in the middle (centrally) in the welding torch device, which has a cylindrical recess 15. A longitudinal axis 16 of the recess 15 is aligned with the rotational axis 8 of the connection flange 6. The leadthrough 14 extends approximately over the entire length of the fixing device and of the receiving device. The upper end of the leadthrough 14 on the robot side is provided with an outer threaded section 17 serving as an electrical connection, to which a coaxial cable 18 (FIG. 1 and FIG. 2) can be detachably fixed by means of screwing on. In addition to the threaded section 17 of the leadthrough, a cone 19 (FIG. 3) may also be provided as a current-conducting contact between a welding power cable 18a of the coaxial cable 18 and the leadthrough 14. In such a coaxial cable 18, the welding power cable 18a, provided with an outer insulation 18b, is arranged coaxially about a central channel 18c. The central channel 18c may be used to supply a welding wire 20 to the welding torch by means of a feed motion and to let an inert gas flow to the welding torch.

In the area of the lower end on the welding torch side, the leadthrough 14 is surrounded by a bell-shaped section 23 (FIG. 3 and FIG. 4) of the stator, which has a circular cross section and which is connected to the leadthrough in an electrically conductive manner. In the exemplary embodiment the bell-shaped section 23 and the leadthrough 14 are connected in one piece. A contact means 24 is arranged on the leadthrough 14 essentially within the bell-shaped section. The contact means 24 has a pressure disk 25 (FIG. 3) and a multipart slip ring 26. The pressure disk 25 is, on the one hand, force-loaded by a plurality of compression springs 27, which act in parallel to the longitudinal axis 16 of the leadthrough 14. The compression springs 27 are supported on the bell-shaped section 23 of the stator and press the pressure disk 25 onto the slip ring 26.

The slip ring 26 is composed of four 90° sliding contact elements 28 each (FIG. 6), which have open pockets on one side each on their radial contact areas opposite one another. Since openings lie directly opposite the pocket-type recesses, two of the pockets each form an essentially closed recess 29. A compression spring 30 is arranged in each of the recesses 29. The directions of action of two radially opposite compression springs 30 run in parallel to one another, while the directions of action of compression springs 30 following one another in the circumferential direction are aligned at right angles to one another. The compression springs 30 cause the sliding contact elements 28 to be pressed on an inner area 33 of the bell-shaped section 23. As material, the sliding contact elements have a good electrical conductor, for example, copper or carbon. The side of the slip ring 26 facing away from the pressure disk 25 acts as a contact surface 34 (FIG. 4) for the transfer of current.

In the direction of the longitudinal axis 16 of the leadthrough 14, a cover 35 (FIG. 3) pushed onto the end of the leadthrough 14 on the welding torch side, which is likewise electrically conductive, is connected to the slip ring 26. By means of the compression springs 27, the cover 35 is constantly in contact with the slip ring via the contact surface 34. The cover 35 is secured to the leadthrough in relation to its axial position in a manner not explained in detail. Moreover, a seal 36 is located between the leadthrough 14 and the cover 35, with which it can be guaranteed that the cover sits on the surface of the leadthrough in a gastight manner. The welding torch 11 can be pushed onto an outer flange surface 37 (FIG. 3) of the cover 35 and be secured. The lower end of the leadthrough 14 opens into the welding torch 11 in this case.

The leadthrough 14 and the bell-shaped section 23 are surrounded by a multipart, hollow-cylinder-type housing 39 of the rotor, which varies in cross section. The housing 39 has either its own insulating material or is electrically insulated from the stator by other components. In the exemplary embodiment shown, the cover 35 is inserted into a lower plastic ring 40 of the housing 39, whereby the plastic ring 40 also surrounds the bell-shaped section 23.

Another hollow cylinder 41 of the housing, which extends up to an end flange 42 of the stator, is connected to the plastic ring 40. The end flange 42 is pushed onto the leadthrough 14 and is located under the cone 19. Rotatability of the hollow cylinder 41 in relation to the leadthrough 14 and, in addition, an electrical insulation, are embodied via two bearings 43 arranged between the end flange 42 and the bell-shaped section 23, for example, insulating slide bearings (plastic slide bearings). An adapter 44 (FIG. 3) of the fixing device, with which the entire welding torch device 7 can be fixed in a detachable manner to the connection flange 6 of the robot, is also integrated on an outer surface of the hollow cylinder (FIG. 1). To this end, the adapter 44 has positive-locking elements, e.g., pins, which fit into corresponding bored holes of the connection flange.

The hollow cylinder 41, the plastic ring 40, the cover 35 and the welding torch 11 are connected to one another in a rotationally fixed manner. Consequently, it is possible to transfer a rotary drive motion of the connection flange 6 via the hollow cylinder 41, the plastic ring 40 and the cover 35 to the welding torch. However, the stator does not perform this rotary motion, since it is rotationally fixed to the robot arm via the coaxial cable 18—and optionally via other fixing media. However, the resistance to torsion, which cables of this type have, may already be sufficient to fix the stator, even though a small percentage of the torque of the drive motion may possibly be transferred to the stator via the bearings 43 because of the frictional moments which cannot be ruled out completely. If it seems necessary, however, the stator may also be additionally fixed to a rotationally fixed component of the robot, for example, via the end flange 42.

The welding current is transferred from the welding power cable 18b via the leadthrough 14 to the bell-shaped section 23 and from here to the sliding contact means. By means of the contact surface 34, the current reaches the cover 35 and from there the welding torch 11.

The inert gas may flow via the coaxial cable 18 through the recess 15 of the leadthrough 14 to the welding torch 11. The welding wire 20 may likewise be fed and resupplied to the welding torch 11 in the same way. If it is necessary, a data cable, not shown, may be integrated into the coaxial cable 18. The data cable is inserted via a hole 42a of the end flange into an outer longitudinal groove 14a of the leadthrough 14 and led to another sliding contact 45, which is not explained in detail. The data cable may be provided, for example, as a signal cable for a so-called switch-off outlet (not shown). Via such a signal cable, the switch-off outlet sends an emergency signal to the control of the robot in case of collision of the welding torch. In the exemplary embodiment shown, the sliding contact 45, which is located in the area between the bell-shaped section 23 and the lower of the two slide bearings 43, is provided for signal transfer between the switch-off outlet and the signal cable.

While a specific embodiment of the invention has been shown and described in detail to illustrate the application of the principles of the invention, it will be understood that the invention may be embodied otherwise without departing from such principles.

1. A welding torch device of a welding robot, which is provided for electric arc welding or MIG or MAG welding, whereby the welding robot has a robot arm, on which is provided a connection device which can be rotated in relation to the robot arm, the device comprising:
a fixing device for attaching the welding torch device to the welding robot;
a receiving device for holding a welding torch and for transferring driven rotatory motions to the welding torch;
an electrical connection for a welding power cable, by means of which a robot side of the welding torch device can be electrically connected to a welding power source;
a current transfer device, via which the welding power cable can be electrically connected to a welding torch side of the welding torch device, wherein the current transfer device has a stator, which is provided for the rotationally fixed arrangement in relation to the robot arm, but can be rotated in relation to the connection device on the welding robot side;
a leadthrough of the stator, through which expendable supply material required for the welding process can be guided in the direction of the receiving device, wherein the receiving device and the fixing device are embodied as rotors, which, as a result, can be rotated in relation to the stator, and the receiving device and/or the fixing device can be connected to the stator in an electrically conductive manner by means of an electric contact means, the fixing device of the being designed for attaching to the connection device of the robot, whereby, by means of the attaching to the connection device of the robot, a rotational axis of the rotor is at least essentially aligned with the rotational axis of the connection device of the robot and the rotor can be rotated about the rotational axis as well as about the stator.

2. A welding torch device in accordance with claim 1, wherein a longitudinal axis of the leadthrough is aligned with the rotational axis of the connection device.

3. A welding torch device in accordance with claim 1, wherein the stator has a rotationally fixed electric connection for the welding cable, through which the rotational axis of the connection device runs.

4. A wleding torch device in accordance with claim 1, further comprising: a lead through of the receiving device for welding wire for the welding torch, whereby the leadthrough of the stator and the leadthrough of the receiving device run at least essentially coaxially to one another.

5. A welding torch device in accordance with claim 1, wherein a longitudinal axis of a recess of the leadthrough of the stator runs at least essentially coaxially to the rotational axis of the rotatory motion of the connection flange on the robot side.

6. A welding torch device in accordance with claim 1, wherein a common rotational axis of the fixing device and the receiving device runs coaxially to a longitudinal axis of the leadthrough of the stator.

7. A welding torch device in accordance with claim 1, further comprising insulating medium, which electrically insulates the fixing device from the stator, whereby the stator and the receiving device are connected to one another in an electrically conductive manner by means of a stator to receiving device contact means.

8. A welding torch device in accordance with claim 7, wherein the stator to receiving device contact means has elements, which are rotated together with the rotor about an axis, whereby the rotational axis of these elements are aligned with the rotational axis of the connection device of the robot.

9. A welding torch device in accordance with claim 7, wherein the contact means is embodied as a sliding contact means.

10. A welding torch device in accordance with claim 9, further comprising a force means, with which at least one said sliding contact element of the sliding contact means can be pressed against a contact partner.

11. A welding torch device in accordance with claim 10, two force means, with which the at least one sliding contact element can be pressed against contact partners in the axial and radial directions in relation to the axis of the rotatory motion.

12. A welding torch device in accordance with claim 11, wherein the force means are springy, and the at least one sliding contact element can be pressed against both a first contact partner radially surrounding the leadthrough and a second contact partner axially offset to the sliding contact element.

13. A welding torch device in accordance with claim 9, further comprising: a bell-shaped section of the stator, in which the sliding contact means is arranged.

14. A welding torch device in accordance with claim 1, further comprising: insulating medium, by means of which the fixing device can be electrically insulated against the current transfer device.

15. A welding torch device in accordance with claim 1, wherein the leadthrough is provided with a recess through which both welding wire and inert gas can be fed to the welding torch as the expendable supply material.

16. A welding torch device in accordance with claim 15, wherein the electric connection for the welding power cable is part of a wall defining the recess.

17. (canceled)

18. A welding robot for welding workpieces, comprising:
a folding arm robot provided with a connection flange; and
a welding torch device connected to said flange, said welding device comprising a fixing device for attaching the welding torch device to the welding robot, a receiving device for holding a welding torch and for transferring driven rotatory motions to the welding torch, an electrical connection for a welding power cable, by means of which a robot side of the welding torch device can be electrically connected to a welding power source, a current transfer device, via which the welding power cable can be electrically connected to a welding torch side of the welding torch device, wherein the current transfer device has a stator, which is provided for the rotationally fixed arrangement in relation to the robot arm, but can be rotated in relation to the connection device on the welding robot side, a leadthrough of the stator, through which expendable supply material required for the welding process can be guided in the direction of the receiving device, wherein the receiving device and the fixing device are embodied as rotors, which, as a result, can be rotated in relation to the stator, and the receiving device and/or the fixing device can be connected to the stator in an electrically conductive manner by means of an electric contact means, the fixing device of the rotor, being designed for attaching to the connection device of the robot, whereby, by means of the attaching to the connection device of the robot, a rotational axis of the rotor is at least essentially aligned with the rotational axis of the connection device of the robot and the rotor can be rotated about the rotational axis as well as about the stator.
